(19) United States
(12) Patent Application Publication
(10) Pub. No.: US 2014/0298795 A1
(43) Pub. Date: Oct. 9, 2014

(54) SYSTEM AND A METHOD FOR DESIGNING HIGH DEGREE OF FREEDOM (DOF) COMPLIANT NANOPOSITIONERS

(71) Applicants: Hoorad Pourzand, Salt Lake City, UT (US); Aria Alasty, Tehran (IR); Reza Ghaemi, Tehran (IR)

(72) Inventors: Hoorad Pourzand, Salt Lake City, UT (US); Aria Alasty, Tehran (IR); Reza Ghaemi, Tehran (IR)

(21) Appl. No.: 13/858,910

(22) Filed: Apr. 8, 2013

(51) Int. Cl. F03G 7/06

(52) U.S. Cl. CPC F03G 7/06
USPC 60/528; 29/888

(57) ABSTRACT

The embodiments herein disclose a high degree of freedom (DOF) compliant nano-positioners and a method to fabricate the high DOF compliant nano-positioners. The system comprising a central stage and a plurality of micromanipulators is connected to the central stage. Each of the plurality of micromanipulators comprises a micro-actuator, a primary long beam and a primary micro beam. The micro-actuator comprises a pair of conducting pads, a secondary micro-beam, a secondary long beam and a box spring. A preset amount of the non-zero voltage is applied on the conducting pads to cause a displacement in the micromanipulator. The embodiments herein also disclose a fabrication method of developing a bi-planar structure for a high degree of freedom nano-positioner.

### CROSS-REFERENCE TO RELATED APPLICATIONS

This application claims priority under 35 U.S.C. .sctn.119 (e) to U.S. Provisional Application No. 61/621,517 filed on Apr. 8, 2012, which is hereby incorporated by reference.

### BACKGROUND

1. Technical Field

The embodiments herein generally relate to a micro electro mechanical systems with thermal micro actuators and particularly relate to a system and a method for generating a movement of nanoscale using thermal micro-actuators. The embodiments herein more particularly relate to a nano-positioner with high degree of freedom (DOF) and a method for fabricating a high DOF nano-positioner.

2. Description of Related Art

A microactuator is a microscopic servomechanism that circulates a measured amount of energy to supports a movement of a plurality of mechanisms connected with the microactuator. Also the microactuators convert energy into a mechanical work at the micro scale.

A thermal microactuator utilizes a property of a conductor that an electron flows from a high potential to a low potential upon providing a thermal energy. In other words the electrons chose a movement path along a direction of energy flow i.e. from a high-energy terminal to a low energy terminal. The thermal microactuator is used for designing a micro-electromechanical system (MEMS) with a highly sophisticated movement.

An existing prior art discloses a system and method for generating a high degree of freedom movement by using a plurality of thermal microactuators. A definite number of microactuators are activated to provide a particular movement. So many microactuators remain resistive for a particular movement.

Another prior art discloses a six-padded microactuator for providing a movement from several micrometers to few nanometers. The existing prior art method provides three conducting pads that are combined to form one actuation unit and two actuation units are combined to form a single microactuator. The three conducting pads are supplied with different voltages to move a microactuator in a particular direction.

However the existing prior art methods fail to provide a lateral, axial and rotational movement through the same set of microactuators. Also the existing prior arts use a high number of microactuators to facilitate various movements. But the system becomes bulky and complicated as the system assembly has a high number of microactuators. Also a utilization of high number of microactuators leads to an asymmetrical post-buckling effect. Further a particular number of microactuators remain resistive while performing a movement thereby reducing the efficiency of the system.

In the view of foregoing, there is a need for a system and method to provide a lateral, an axial and a rotational movement by using a same set of microactuators. Further there is a need for a system and method which implements less number of microactuators. Still further there is a need for a system and method with negligible resistive areas or microactuators.

The above-mentioned shortcomings, disadvantages and problems are addressed herein and which will be understood by reading and studying the following specification.

### OBJECTS OF THE EMBODIMENTS

The primary object of the embodiment herein is to provide a nano-positioner with high degree of freedom (DOF) and a method for designing a high degree of freedom (DOF) nano-positioner using at-least a 2-DOF micromanipulator.

Another object of the embodiments herein is to provide a nano positioned system and method for facilitating a lateral, an axial and a rotational movement using a same set of micro actuators.

Yet another object of the embodiments herein is to provide a nano-positioner system for facilitating a high displacement while performing a lateral, an axial and a rotational movement.

Yet another object of the embodiments herein is to provide a nano-positioner system for providing a symmetrical buckling effect while performing a lateral, an axial and a rotational movement.

Yet another object of the embodiments herein is to provide a nano-positioner system for providing an in plane and an out-of-plane movement.

Yet another object of the embodiments herein is to provide a nano-positioner system for providing a symmetrical displacement while performing a lateral, an axial and a rotational movement.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating the preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein disclose high degree of freedom (DOF) compliant nano-positioner system. The system comprising a central stage and a plurality of micromanipulators connected to the central stage. Each of the plurality of micromanipulators comprises a micro-actuator, a primary long beam and a primary micro beam. The micro-actuator comprises a pair of conducting pads, a secondary micro-beam, a secondary long beam and a box spring.

According to one embodiment herein, a first tip of the primary micro-beam is connected to the central stage. A second tip of the primary micro-beam is connected with a first tip of the primary long beam. A second tip of the primary long beam is connected to the centre of a lateral side of the box spring. A first tip of the secondary long beam is connected to the centre of a lateral side of the box spring. The primary long beam and the secondary long beam are connected to the box spring in perpendicular to each other. A second tip of the secondary long beam is orthogonally connected to a centre of the secondary micro-beam. A first tip of the pair of conducting pads is connected to the secondary micro-beam orthogonally. A second tip of the pair of conducting pads is connected to a voltage source for supplying a preset amount of the voltage to the pair of conducting pads. The preset amount of the voltage is a voltage value required to cause a displacement in the micromanipulator.

According to one embodiment herein, the first tip of at-least two primary long beams are connected together to form a flexural joint of a micro-actuator. The second tip of the primary long beam is connected to the flexural joint of the micro-actuator to form the micromanipulator.

According to one embodiment herein, a degree of freedom (DOF) of the nano-positioner comprises a lateral movement and a rotational movement of the center stage.

According to one embodiment herein, a potential difference is developed between the two ends of the secondary micro-beam to allow a lateral movement of the secondary long beam. A voltage applied on the conducting pads that are arranged opposite to each other on a same line is equal.

According to one embodiment herein, a potential difference is developed between the two ends of the secondary micro-beam to allow a rotational movement of the secondary long beam. A voltage applied on the conducting pads that are arranged opposite to each other on a diagonal line is equal.

According to one embodiment herein, an axial stiffness of the box spring is increased to increase an output displacement of the primary long beam of the nano-positioners. The output displacement is a lateral displacement or a rotational displacement or a combination of both.

According to one embodiment herein, a flexural stiffness of the box spring is reduced to increase an output displacement of the primary long beam of the nano-positioners. The output displacement is a lateral displacement or a rotational displacement or a combination of both.

According to one embodiment herein, the primary long beam further comprises a serpentine shaped spring to increase an in-plane rigidity of the nano-positioner.

According to one embodiment herein, the primary long beam is arranged in a shape of a ladder to avoid an out-of-plane displacement.

According to one embodiment herein, at-least four micromanipulators are connected to at-least one central stage for providing six degrees of freedom. The six degrees of freedom comprises a movement in an X-plane, a Y-plane, a Z-plane, a θx plane, a θy plane and a θz plane.

According to one embodiment herein, the at-least four micromanipulators are fabricated with a plurality of Double-Deck-SOI wafers. The Double-Deck-SOI wafers are connected to at-least one central stage for providing a degree of freedom in at-least three directions. The degree of freedom in at-least three directions comprises a movement in an X-plane, a Y-plane and a Z-plane.

According to one embodiment herein, the at least four micromanipulators with the ladder shaped primary long beam are connected to one central stage for providing at least 4-degrees of freedom. The at least 4 degrees of freedom comprise a movement in an X-plane, a Y-plane, a Z-plane and a θx plane or a θy plane or a θz plane.

According to one embodiment herein, the at-least four Double-Deck-SOI micromanipulators along with the primary long beam having the serpentine shaped spring are connected to at-least one central stage for providing at least five degrees of freedom. The at least five degrees of freedom comprise a movement in an X-plane, a Y-plane, a Z-plane, a θy plane and a θz plane.

According to one embodiment herein, the micro-actuators are aligned along a direction of 100° to 110° to increase a buckling displacement. The buckling displacement is a lateral displacement or a rotational displacement or a combination of both.

According to one embodiment herein, a modulus of elasticity of the nano-positioner is varied from 169 Pa to 130 Pa for a respective variation in an alignment of the micro-actuators from 100° direction to 110° direction to increase the buckling displacement.

The embodiments herein disclose a method for designing a high degree of freedom (DOF) nano-positioners from at-least 2-DOF micromanipulator. The method comprises forming a plurality of micromanipulators, which further comprises forming a plurality of microactuators, a primary long beam and a primary micro beam. The formation of micromanipulators is followed by connecting the plurality of micromanipulators on a central stage micro-actuator.

According to one embodiment herein, forming the micro-actuator further comprises connecting a first tip of the primary micro-beam to the central stage, connecting a second tip of the primary micro-beam to a first tip of the primary long beam, connecting a second tip of the primary long beam to a centre of a lateral side of the box spring, connecting a first tip of the secondary long beam to the centre of a lateral side of the box spring, connecting a second tip of the secondary long beam orthogonally to a centre of the secondary micro-beam, connecting a first tip of the pair of conducting pads to the secondary micro-beam orthogonally, connecting a second tip of the pair of conducting pads to a voltage source for supplying a preset amount of the voltage of the pair of conducting pads. The primary long beam and the secondary long beam are connected to the box spring in perpendicular to each other. The preset amount of the voltage is a voltage value required to cause a displacement in the micromanipulator.

According to one embodiment herein, a non-zero voltage is provided to the conducting pads of the pair of micromanipulators for facilitating a degree of freedom. The degree of freedom is a lateral movement or a rotational movement or a combination of both.

The embodiments herein disclose a fabrication method for a bi-planar structure with a high degree of freedom nano-positioner. The fabrication method comprises the steps of developing a lower layer and an upper layer. The development of the lower layer comprises developing a potassium hydride (KOH) truncated pyramid hole. The KOH truncated pyramid hole acts as a handle wafer. The development of the upper layer further comprises developing a wafer with three holes. The three holes lie in the same plane on the wafer and the two holes lie on two opposite sides of a central hole. A width of the two holes arranged on the two opposite sides of the central hole is less than a width of the central hole. The fabrication method further comprises masking a developed wafer with a three holes, dry etching a masked wafer with three holes, attaching the developed upper layer and the lower layer through a fusion bonding to form a bi-planar wafer and performing a chemical mechanical planarization (CMP) over the bi-planar wafer. A dry etching is done on a double polished wafer. The handle wafer is attached with the conducting pad. The CMP is done to reduce the thickness of the bi-planar wafer. A potassium hydroxide (KOH) etching and a deep reactive ion etching (DRIE) method are suitably used in place of CMP method.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The other objects, features and advantages will occur to those skilled in the art from the following description of the preferred embodiment and the accompanying drawings in which:

FIG. 1 illustrates a schematic diagram of a nano-positioner with three 6-paded micromanipulators, according to a prior art.

FIG. 2 illustrates a schematic diagram of a microactuator provided various voltages applied to the conducting pads of the microactuator, according to a prior art.

FIG. 3A illustrates a schematic diagram of a microactuator indicating a downward movement of a microactuator, according to a prior art.

FIG. 3B illustrates a schematic diagram of a microactuator indicating an upward movement of a microactuator, according to a prior art.

FIG. 4 illustrates a schematic diagram of a high DOF nano-positioner, according to one embodiment herein.

FIG. 5 illustrates a schematic diagram of a 3-padded microactuator, according to one embodiment herein.

FIG. 6 illustrates a schematic diagram of a 2-padded microactuator, according to one embodiment herein.

FIG. 7 illustrates a schematic line diagram of the 2-padded microactuators indicating a plurality of linear movements, according to one embodiment herein.

FIG. 8 illustrates a schematic line diagram of the 2-padded microactuators indicating a plurality of lateral and rotational movements, according to one embodiment herein.

FIG. 9 illustrates a schematic diagram of the manipulator with a box spring indicating a movement, according to one embodiment herein.

FIG. 10A illustrates a schematic line diagram of the 2-padded microactuators indicating a plurality of out-of-plane movement in a downward direction, according to one embodiment herein.

FIG. 10B illustrates a schematic line diagram of the 2-padded microactuators indicating a plurality of out-of-plane movement in an upward direction, according to one embodiment herein.

FIG. 11 illustrates a top plan view of a nano-positioner formed by a combination of four 2-DOF micromanipulators, according to one embodiment herein.

FIG. 12 illustrates a schematic diagram of the nano-positioner indicating an upward movement, according to one embodiment herein.

FIG. 13 illustrates a schematic diagram of the nano-positioner indicating a lateral movement, according to one embodiment herein.

FIG. 14 illustrates a top view of the nano-positioner indicating an in-plane rotational movement, according to one embodiment herein.

FIG. 15 illustrates a schematic diagram of the nano-positioner indicating an out-of-plane rotational movement, according to one embodiment herein.

FIG. 16 illustrates a topside perspective view of a micromanipulator with a plurality of Double-Deck-SOI wafers, according to one embodiment herein.

FIG. 17 illustrates a schematic diagram of a pair of micromanipulators with a serpentine shaped spring attached to a primary long beam, according to one embodiment herein.

FIG. 18 illustrates a side perspective view of a nano-positioner fabricated with a plurality of Double-Deck-SOI wafers along with serpentine shaped spring attached to a primary long beam, according to one embodiment herein.

FIG. 19 illustrates a side perspective view of a micromanipulator fabricated with a serpentine shaped primary long beam, according to one embodiment herein.

FIG. 20 illustrates a graph representing a comparison between a temperature distribution obtained with an analytical element method and a finite element method (FEM), according to one embodiment herein.

FIG. 21 illustrates a schematic diagram indicating the various stages of a fabrication process of silicon wafers using a dry undercutting process in a manufacture of a micromanipulator, according to one embodiment herein.

FIG. 22A illustrates a schematic diagram indicating a fabrication of a silicon wafer with KOH (potassium hydroxide) truncated pyramid hole in a manufacture of a micromanipulator, according to one embodiment herein.

FIG. 22B illustrates a schematic diagram indicating a fabrication of a truncated silicon wafer in a manufacture of a micromanipulator, according to one embodiment herein.

FIG. 22C illustrates a schematic diagram indicating a fusion process of the silicon wafers shown in FIG. 22A and FIG. 22B, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein disclose high degree of freedom (DOF) compliant nano-positioner system. The system comprising a central stage and a plurality of micromanipulators connected to the central stage. Each of the plurality of micromanipulators comprises a micro-actuator, a primary long beam and a primary micro beam. The micro-actuator comprises a pair of conducting pads, a secondary micro-beam, a secondary long beam and a box spring.

According to one embodiment herein, a first tip of the primary micro-beam is connected to the central stage. A second tip of the primary micro-beam is connected with a first tip of the primary long beam. A second tip of the primary long beam is connected to the centre of a lateral side of the box spring. A first tip of the secondary long beam is connected to the centre of a lateral side of the box spring. The primary long beam and the secondary long beam are connected to the box spring in perpendicular to each other. A second tip of the secondary long beam is orthogonally connected to a centre of the secondary micro-beam. A first tip of the pair of conducting pads is connected to the secondary micro-beam orthogonally. A second tip of the pair of conducting pads is connected to a voltage source for supplying a preset amount of the voltage to the pair of conducting pads. The preset amount of the voltage is a voltage value required to cause a displacement in the micromanipulator.

According to one embodiment herein, the first tip of at-least two primary long beams are connected together to form a flexural joint of a micro-actuator. The second tip of the primary long beam is connected to the flexural joint of the micro-actuator to form the micromanipulator.

According to one embodiment herein, a degree of freedom (DOF) of the nano-positioner comprises a lateral movement and a rotational movement of the center stage.

According to one embodiment herein, a potential difference is developed between the two ends of the secondary micro-beam to allow a lateral movement of the secondary long beam. A voltage applied on the conducting pads arranged opposite to each other on a same line is equal.

According to one embodiment herein, a potential difference is developed between the two ends of the secondary micro-beam to allow a rotational movement of the secondary long beam. A voltage applied on the conducting pads arranged opposite to each other on a diagonal line is equal.

According to one embodiment herein, an axial stiffness of the box spring is increased to increase an output displacement of the primary long beam of the nano-positioners. The output displacement is a lateral displacement or a rotational displacement or a combination of both.

According to one embodiment herein, a flexural stiffness of the box spring is reduced to increase an output displacement of the primary long beam of the nano-positioners. The output displacement is a lateral displacement or a rotational displacement or a combination of both.

According to one embodiment herein, the primary long beam further comprises a serpentine shaped spring to increase an in-plane rigidity of the nano-positioner.

According to one embodiment herein, the primary long beam is arranged in a shape of a ladder to avoid an out-of-plane displacement.

According to one embodiment herein, an at-least four micromanipulators are connected to at-least one central stage for providing a six degrees of freedom. The six degrees of freedom comprises a movement in an X-plane, a Y-plane, a Z-plane, a θx plane, a θy plane and a θz plane.

According to one embodiment herein, the at-least four micromanipulators are fabricated with a plurality of Double-Deck-SOI wafers. The Double-Deck-SOI wafers are connected to at-least one central stage for providing a degree of freedom in at-least three directions. The degree of freedom in at-least three directions comprises a movement in an X-plane, a Y-plane and a Z-plane.

According to one embodiment herein, the at least four micromanipulators with the ladder shaped primary long beam are connected to one central stage for providing at least 4-degrees of freedom. The at least 4 degrees of freedom comprise a movement in an X-plane, a Y-plane, a Z-plane and a θx plane or a θy plane or a θz plane.

According to one embodiment herein, the at-least four Double-Deck-SOI micromanipulators along with the primary long beam having the serpentine shaped spring are connected to at-least one central stage for providing at least five degrees of freedom. The at least five degrees of freedom comprise a movement in an X-plane, a Y-plane, a Z-plane, a θy plane and a θz plane.

According to one embodiment herein, the micro-actuators are aligned along a direction of 100° to 110° to increase a buckling displacement. The buckling displacement is a lateral displacement or a rotational displacement or a combination of both.

According to one embodiment herein, a modulus of elasticity of the nano-positioner is varied from 169 Pa to 130 Pa for a respective variation in an alignment of the micro-actuators from 100° direction to 110° direction to increase the buckling displacement.

The embodiments herein disclose a method for designing a high degree of freedom (DOF) nano-positioners from at-least 2-DOF micromanipulator. The method comprises forming a plurality of micromanipulators, which further comprises forming a plurality of microactuators, a primary long beam and a primary micro beam. The formation of micromanipulators is followed by connecting the plurality of micromanipulators on a central stage micro-actuator.

According to one embodiment herein, forming the micro-actuator further comprises connecting a first tip of the primary micro-beam to the central stage, connecting a second tip of the primary micro-beam to a first tip of the primary long beam, connecting a second tip of the primary long beam to a centre of a lateral side of the box spring, connecting a first tip of the secondary long beam to the centre of a lateral side of the box spring, connecting a second tip of the secondary long beam orthogonally to a centre of the secondary micro-beam, connecting a first tip of the pair of conducting pads to the secondary micro-beam orthogonally, connecting a second tip of the pair of conducting pads to a voltage source for supplying a preset amount of the voltage of the pair of conducting pads. The primary long beam and the secondary long beam are connected to the box spring in perpendicular to each other. The preset amount of the voltage is a voltage value required to cause a displacement in the micromanipulator.

According to one embodiment herein, a non-zero voltage is provided to the conducting pads of the pair of micromanipulators for facilitating a degree of freedom. The degree of freedom is a lateral movement or a rotational movement or a combination of both.

The embodiments herein disclose a fabrication method for a bi-planar structure with a high degree of freedom nano-positioner. The fabrication method comprises the steps of developing a lower layer and an upper layer. The development of the lower layer comprises developing a potassium hydride (KOH) truncated pyramid hole. The KOH truncated pyramid hole acts as a handle wafer. The development of the upper layer further comprises developing a wafer with three holes. The three holes lie in the same plane on the wafer and the two holes lie on two opposite sides of a central hole. A width of the two holes arranged on the two opposite sides of the central hole is less than a width of the central hole. The fabrication method further comprises masking a developed wafer with a three holes, dry etching a masked wafer with three holes, attaching the developed upper layer and the lower layer through a fusion bonding to form a bi-planar wafer and performing a chemical mechanical planarization (CMP) over the bi-planar wafer. A dry etching is done on a double polished wafer. The handle wafer is attached with the conducting pad. The CMP is done to reduce the thickness of the bi-planar wafer. A potassium hydroxide (KOH) etching and a deep reactive ion etching (DRIE) method is suitably used in place of CMP method.

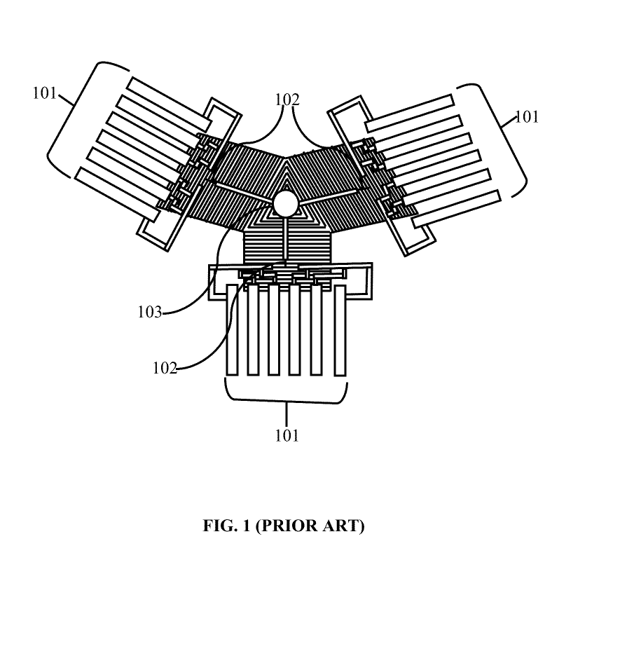

FIG. 1 illustrates a schematic diagram of a nano-positioner with three 6-paded micromanipulators, according to one prior art. With respect to FIG. 1, the 6-paded micromanipulator comprises six microactuators. The microactuators are bidirectional in nature and comprise three conducting pads 101 which are further connected to a microactuator tip 102. The three conducting pads 101 provide a movement of the microactuator in the various lateral directions. The microactuator tip 102 is further connected to a central stage 103. The microactuators are provided in a U-shape.

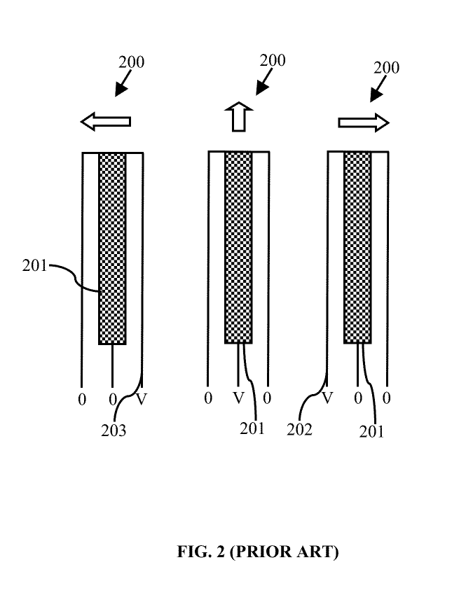

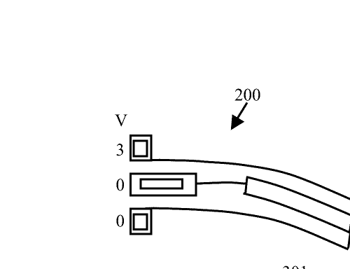

FIG. 2 illustrates a schematic diagram of a microactuator provided with conducting pads applied with various voltages, according to one prior art. With respect to FIG. 2, the microactuator 200 is moved towards the right, when the left pad 202 is connected to a positive voltage and two other conducting pads 201 and 203 are grounded. Similarly when the right conducting pad 203 is connected to a positive voltage and two other conducting pads 201 and 202 are grounded, then the microactuator 200 is moved towards the left. When the central conducting pad 201 is connected to the positive voltage and two other conducting pads 202 and 203 are grounded, then microactuator 200 is elongated along an axis which is parallel to or in-line with the connection of microactuator tip to the central stage. The movement of the microactuator 200 is due to a generation of a higher current density in the conducting pad applied with a voltage than that of the grounded conducting pads. The central conducting pad 201 is wider than the other two conducting pads to generate a lower heat and lower expansion. The application of different voltages on each conducting pad of the 6-padded microactuator results in an unequal elongation in each conducting pad. The unequal elongation deflects the microactuator 200 towards a direction opposite to the conducting pad in which a higher voltage is applied.

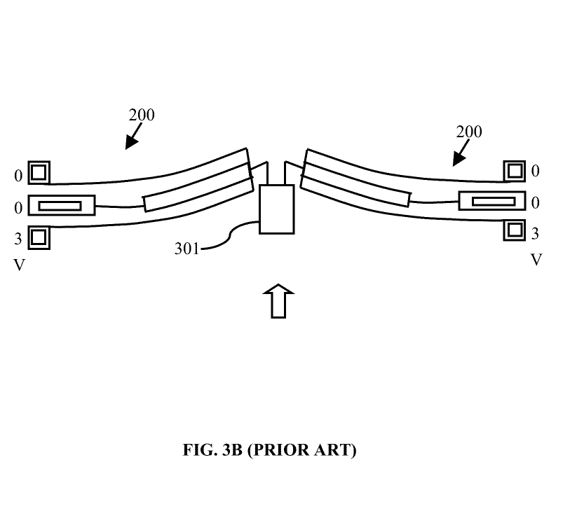

FIG. 3A illustrates a schematic diagram of a microactuator with the box spring indicating a downward movement, according to one prior art. With respect to FIG. 3A, the net movement of the microactuator 200 is in a downward direction due to an application of a positive voltage at an uppermost conducting pad. The downward movement of the microactuator 200 further leads to a downward displacement of a central stage 301.

FIG. 3B illustrates a schematic diagram of a microactuator with the box spring indicating an upward movement, according to one prior art. With respect to FIG. 3B, the net movement of the microactuator 200 is in an upward direction due to application of the positive voltage at a lowermost conducting pad. The upward movement of the microactuator 200 further leads to an upward displacement of the central stage 301. Due to an out-of-axis buckling characteristic, an undesirable axial elongation of a U-shaped microactuator 200 occurs which further leads to an unequal displacement in different direction.

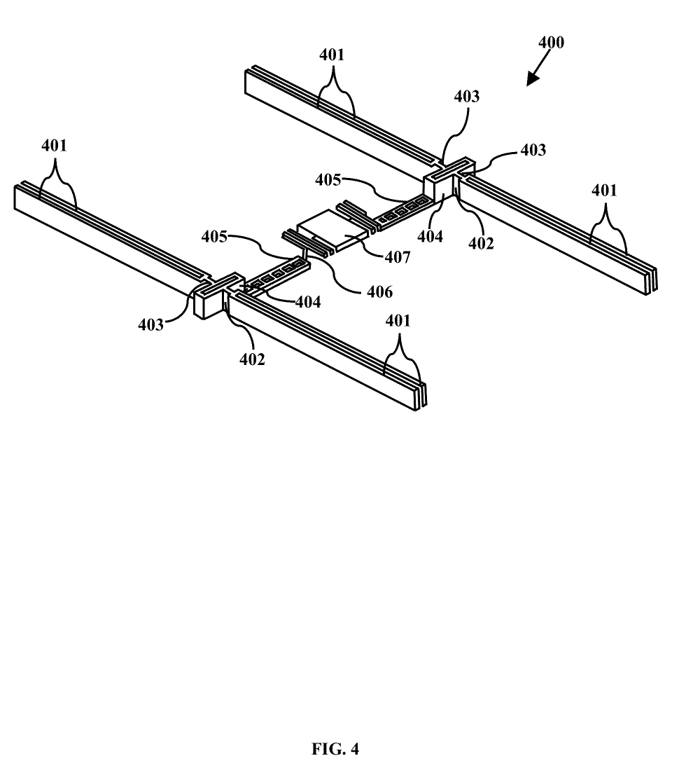

FIG. 4 illustrates a schematic diagram of a high DOF nano-positioner, according to one embodiment herein. With respect to FIG. 4, the system comprises a central stage 407 and a plurality of micromanipulators connected to the central stage. Each micromanipulator comprises a micro-actuator, a primary long beam 405 and a primary micro beam 406. The micro-actuator comprises a pair of conducting pads 401, a secondary micro-beam 402, a secondary long beam 403 and a box spring 404.

A first tip of the primary micro-beam 406 is connected to the central stage 407. A second tip of the primary micro-beam 406 is connected to a first tip of the primary long beam 405. A second tip of the primary long beam 405 is connected to the centre of a lateral side of the box spring 404. A first tip of the secondary long beam 403 is connected to the centre of a lateral side of the box spring 404. The primary long beam 405 and the secondary long beam 403 connected to the box spring 404 are perpendicular to each other. A second tip of the secondary long beam 403 is orthogonally connected to a centre of the secondary micro-beam 402. A first tip of the pair of conducting pads is connected to the secondary micro-beam orthogonally. A second tip of the pair of conducting pads 401 is connected to a voltage source for supplying a preset amount of the voltage of the pair of conducting pads 401. The preset value of the voltage is a voltage value required to cause a displacement in the micromanipulator.

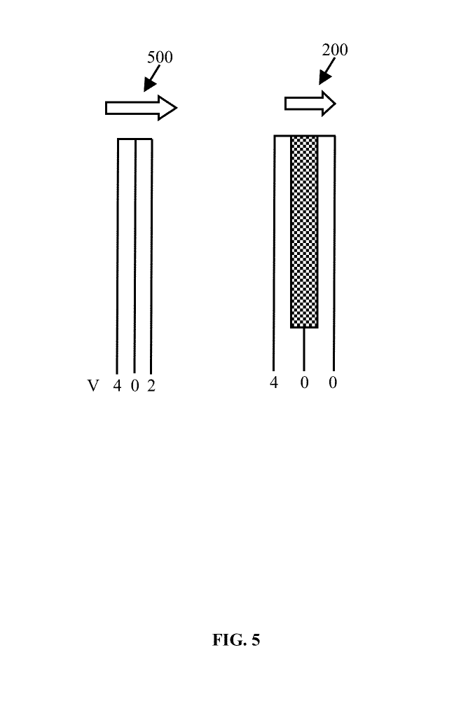

FIG. 5 illustrates a schematic diagram of a three padded microactuator, according to one embodiment herein. With respect to FIG. 5, the microactuator 200 is provided with a central conducting pad having a width more than that of the other two corner conducting pads. The width of the central conducting pad is made same as of the two corner conducting pads in the microactuator 500, which distributes the strain energy uniformly over at-least three conducting pads. At-least the three conducting pads with equal width increase a fatigue life of the microactuator 500. Also the voltage applied on one of the corner conducting pads is half of the voltage applied on the other conducting pad. The reduction in the width of the central conducting pad increases a lateral displacement of the microactuator 500 substantially up to three times during an absence of an external force i.e. an applied voltage.

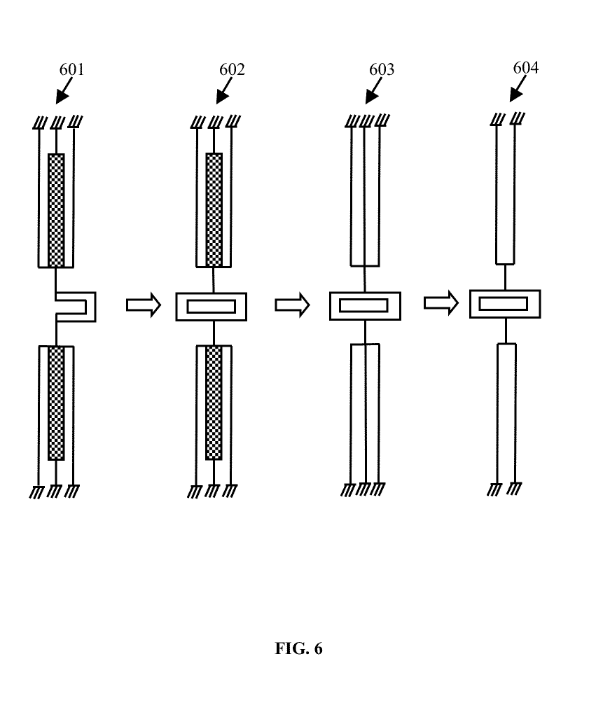

FIG. 6 illustrates a schematic diagram of a two-padded microactuator, according to one embodiment herein. With respect to FIG. 6, the configuration of the microactuator 602 is an evolved design over the microactuator 601. The microactuator 602 has a box spring to provide an increased symmetrical displacement outputs. The microactuator 603 includes at-least 3 conducting pads of similar width. The similar width of the conducting pads facilitates an equal distribution of the current density, which is developed due to an application of a voltage at each of the conducting pads. The microactuator 604 includes at-least two conducting pads which facilitates a higher displacement during a movement of the nano-positioner.

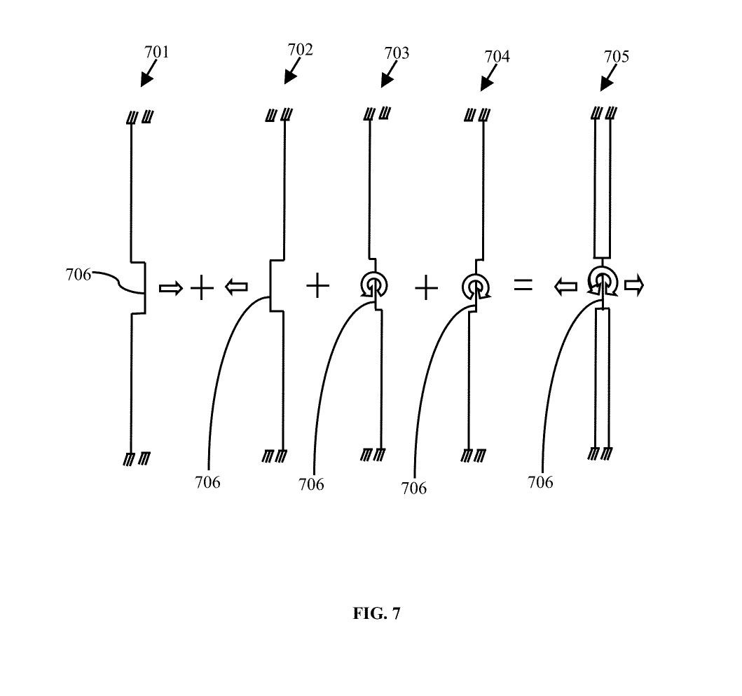

FIG. 7 illustrates a schematic line diagram of the 2-padded microactuators indicating a plurality of linear movement, according to one embodiment herein. With respect to FIG. 7, the two 2-padded microactuator shares a common central stage 706. The microactuator 701 shows a rightwards-lateral movement. The left conducting pads of the microactuator 701 are grounded and the right conducting pads are supplied with a particular voltage. The difference in the applied voltage on the conducting pads generates a current drifting from left to right. The central stage 706 moves towards the right due to the generated current drift.

The right conducting pads of the microactuator 702 are grounded and the left conducting pads are supplied with a particular voltage. The difference in the applied voltage on the conducting pads generates a current drifting from right to left. The central stage 706 moves towards the left due to the generated current drift.

The left conducting pad of the upper part and the right conducting pad of the lower part of the microactuator 703 are supplied with a specific voltage. Further the right conducting pad of the upper part and the left conducting pad of the lower part of the microactuator 703 are grounded. The combination of the four conducting pads in the microactuator 703 produces an anti-clockwise rotation of the central stage 706.

The right conducting pad of the upper part and the left conducting pad of the lower part of the microactuator 704 are supplied with a specific voltage. Further the left conducting pad of the upper part and the right conducting pad of the lower part of the microactuator 704 are grounded. The combination of the four conducting pads in the microactuator 704 produces clockwise rotation of the central stage 706.

The microactuator 705 shows a combination of previous configuration of the microactuators (701-704). The microactuator 705 comprises a movement provided by a parallel beam microactuator and a buckling microactuator. The grounding of the inline conducting pads leads to a generation of heat in the adjacent conducting pads. Thus the combination of the four conducting pads acts as a parallel beam microactuator.

Also the grounding of the diagonally opposite conducting pads leads to a generation of heat in the adjacent conducting pads. Thus the combination of the four conducting pads acts a buckling microactuator.

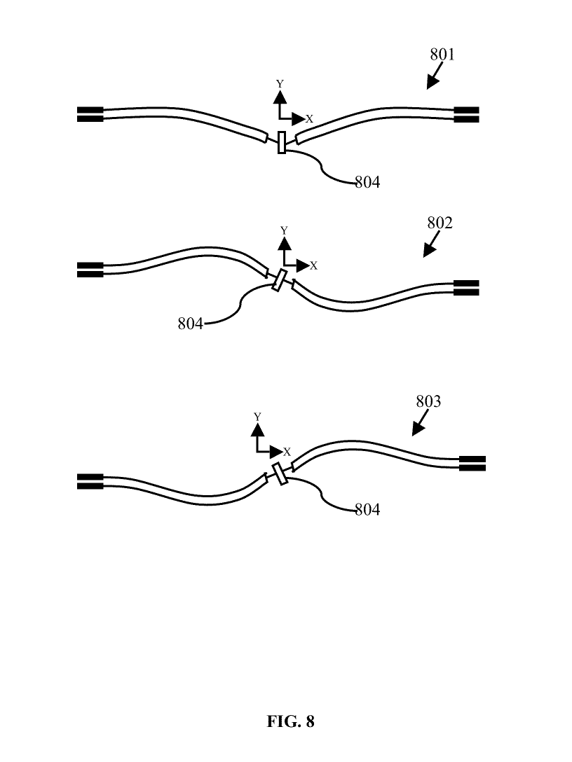

FIG. 8 illustrates a schematic line diagram of the 2-padded microactuators indicating a plurality of lateral and rotational movements, according to one embodiment herein. With the respect to the FIG. 8, a non-zero voltage is applied on the conducting pads of the microactuator 801-803. The upper conducting pads of the microactuator 801 are supplied with a voltage, which is higher than the voltage applied on the lower conducting pads. The upper conducting pads are elongated more than the lower conducting pads due to the application of higher voltage. The elongation of the pads is in a curved manner rather than a linear elongation due to the internal material properties of the conducting pads. Thus an unequal elongation of the conducting pads leads to a net downward movement of a box spring 804 connected to the conducting pads. The movement of the box spring is in an upward direction when the voltage applied on the lower conducting pads is more than the voltage applied on the upper conducting pads.

The upper conducting pad of the left portion of the microactuator 802 is supplied with a voltage, which is higher than a voltage applied on the lower conducting pad. Thus an elongation of the upper conducting pad of the left half of the microactuator 802 is more than the elongation of the lower conducting pad which tends to move the box spring in a rightward direction. Further the lower conducting pad of the right portion of the microactuator 802 is supplied with a voltage, which is higher than a voltage applied on the upper conducting pads. Thus an elongation of the lower conducting pad of the right half of the microactuator 802 is more than the elongation of the upper conducting pad which tends to move the box spring in a leftward direction. Hence the net counteracting movement of the left and right portion of the microactuator 802 leads to a clockwise rotation of the box spring 804.

The lower conducting pad of the left portion of the microactuator 803 is supplied with a voltage, which is higher than the voltage applied on the upper conducting pad. Thus an elongation of the lower conducting pad of the left half of the microactuator 803 is more than the elongation of the upper conducting pad which tends to move the box spring in a leftward direction. Further the lower conducting pad of the right portion of the microactuator 803 is supplied with a voltage, which is higher than the voltage applied on the upper conducting pads. Thus an elongation of the lower conducting pad of the right half of the microactuator 803 is more than the elongation of the upper conducting pad which tends to move the box spring in rightward direction. Hence the net counteracting movement of the left and right portion of the microactuator 803 leads to an anti-clockwise rotation of the box spring 804.

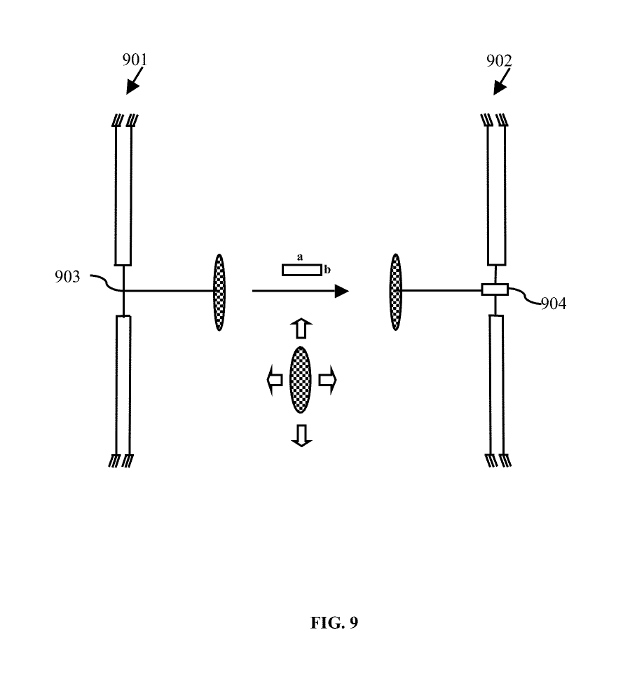

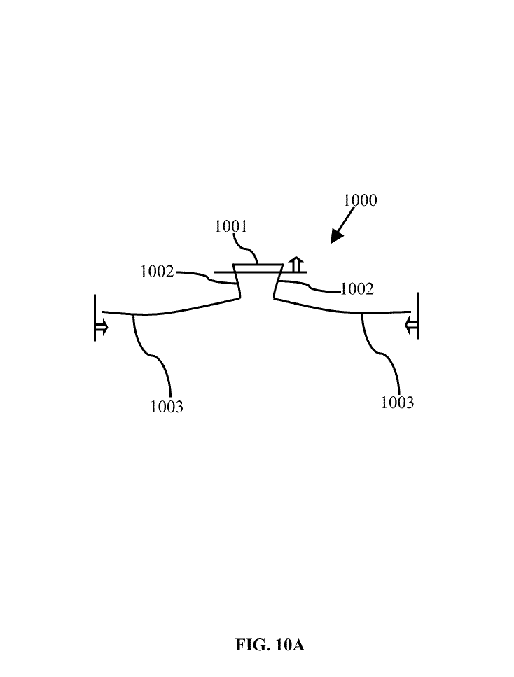

FIG. 9 illustrates a schematic diagram of the manipulator after an addition of a box spring indicating a movement, according to one embodiment herein. With respect to FIG. 9, the microactuator 901 comprises a pair pads connected to each other through the respective secondary long beams. The tip of the secondary long beam is attached together by implementing a flexural joint 903. The flexural joint 903 is formed by soldering the tip of two secondary long beams. The flexural joint 903 is further attached to the primary long beam, which is further connected to the central stage. The lateral and rotational displacement of the microactuator 901 facilitates an in-plane 2-DOF movement of the central stage.

Clamping the box spring 904 to the tip of both the secondary long beams forms the microactuator 902. The box spring increases a maximum displacement of the microactuator 902 in all possible directions.

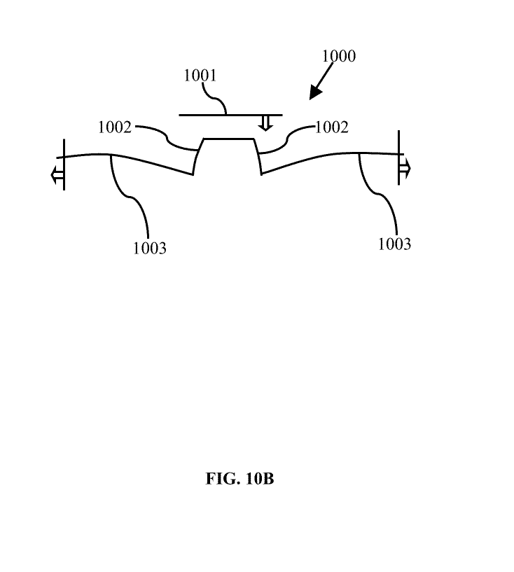

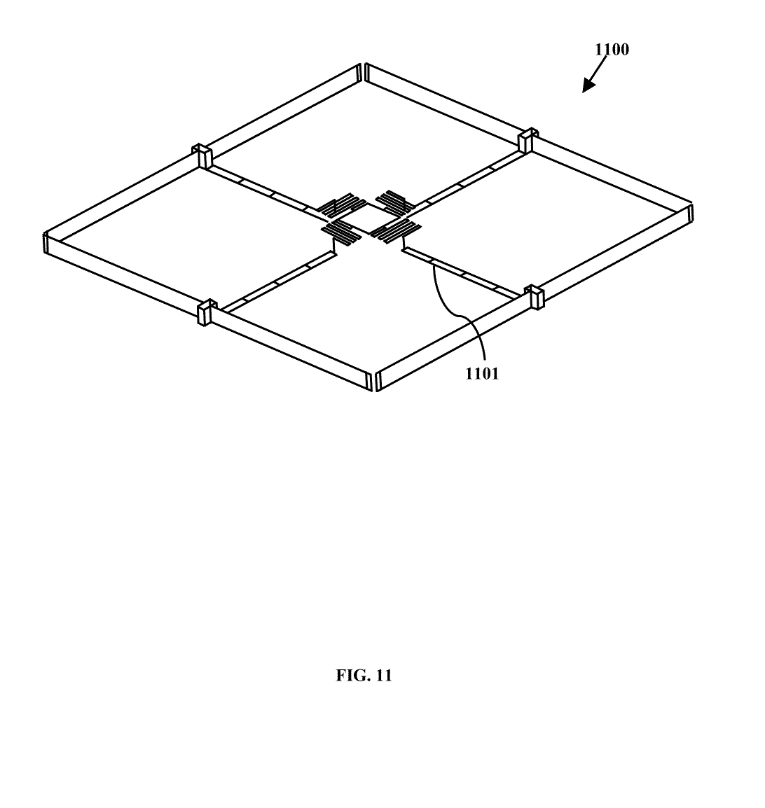

FIG. 10A illustrates a schematic line diagram of the 2-padded microactuators indicating a plurality of out-of-plane movement in a downward direction, according to one embodiment herein. With respect to FIG. 10A, the movement of the primary long beam 1003, away from the central stage 1001 leads to a pull force applied on the primary microbeam 1002. The pull force applied on the primary microbeam 1002 leads to a downward movement of the central stage 1001.

FIG. 10B illustrates a schematic line diagram of the 2-padded microactuators indicating a plurality of out-of-plane movement in an upward direction, according to one embodiment herein. With respect to FIG. 10B, the movement of the primary long beam 1003 towards the central stage 1001 leads to a push force applied on the primary microbeam 1002. The push force applied on the primary microbeam 1002 leads to an upward movement of the central stage 1001.

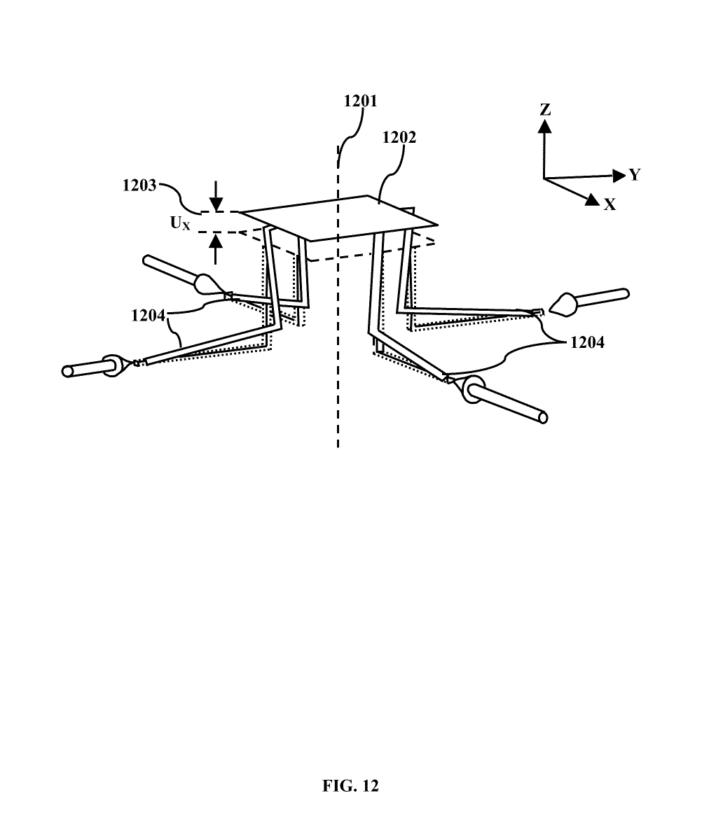

FIG. 11 illustrates a top plan view of a nano-positioner formed by combination of four 2-DOF micromanipulators, according to one embodiment herein. With respect to FIG. 11, the primary long beam is provided in form of a ladder 1101 to facilitate a high or large out-of plane movement of the central stage of the nano-positioner. Also the ladder shaped 1101 primary long beam provides a high rigidity to the nano-positioner during an in-plane movement. Further the nano-positioner has four actuation units, which enhance the rigidity of the nano-positioner and control the nano-positioner during an in-plane and an out-of-plane movement.

FIG. 12 illustrates a side perspective view of the nano-positioner indicating an upward movement, according to one embodiment herein. With respect to FIG. 12, movement of the primary long beams 1204 towards the central stage 1202 generates a vertical push force over the primary microbeam. The vertical push force applied over the primary microbeam leads to an upward movement 1203 of the central stage 1202.

Also, a movement of the primary long beam 1204 away from the central stage 1202 generates a vertical pull force over the primary microbeam. The vertical pull force applied over the primary microbeam leads to a downward movement of the central stage 1202. The movement of the primary long beam 1204 is symmetrical about a central axis 1201.

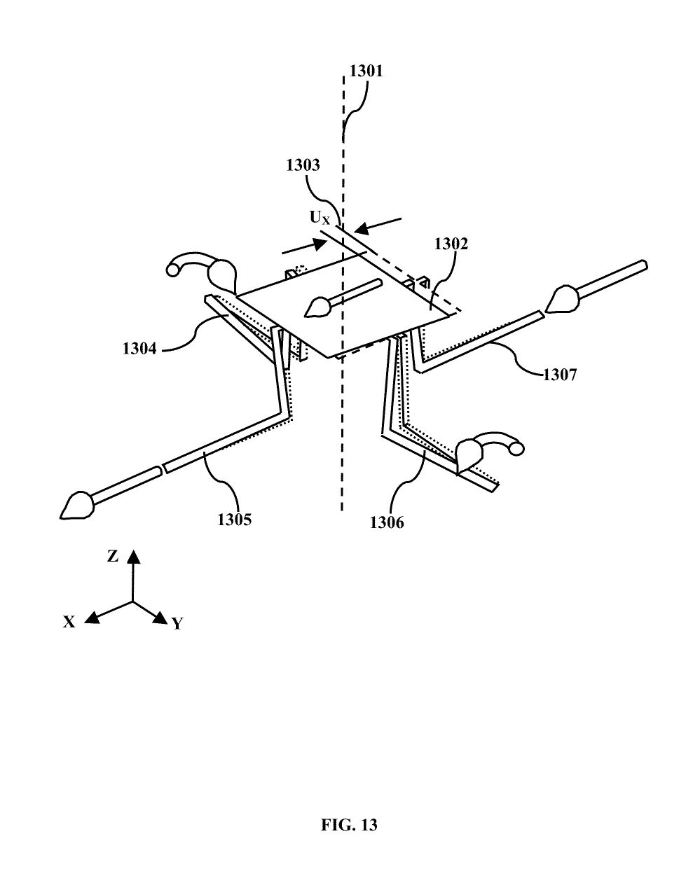

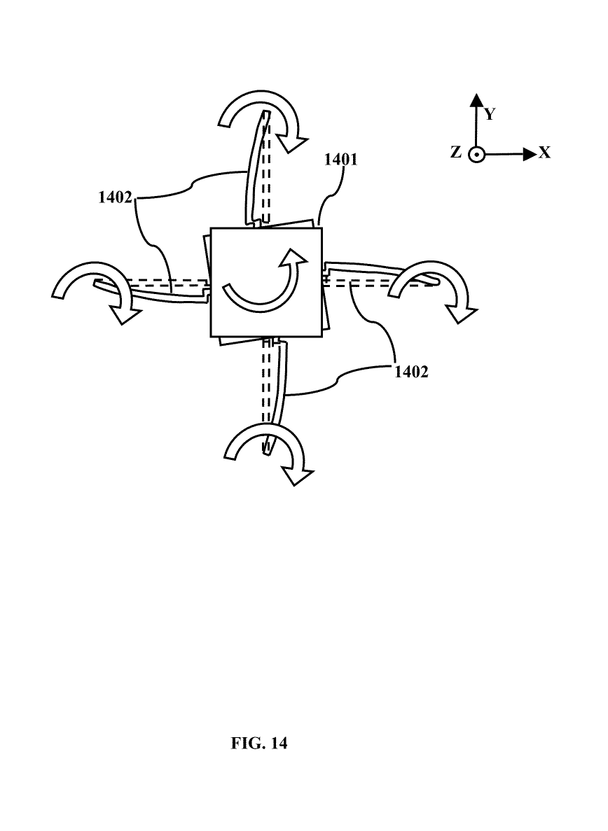

FIG. 13 illustrates a side perspective view of a lateral movement of the nano-positioner, according to one embodiment herein. With respect to a FIG. 13, a primary long beam 1305 is moved away from a central axis of the central stage 1302 which generates a horizontal pull force over the primary microbeam. The horizontal pull force applied on the primary microbeam leads to a sideward movement 1303 of the central stage 1302.

Also a primary long beam 1307 is moved away from an axis of the central stage 1302, which applies a horizontal push force over the primary microbeam. The direction of the horizontal push is along the direction of the pull force over the primary long beam 1305. The horizontal push force applied on the primary microbeam leads to a lateral movement of the central stage 1302.

Further a lateral movement of the primary long beams 1304 and 1306 is along a direction of the pull force over the primary long beam 1305. The lateral movement of the secondary long beams 1304 and 1306 leads to a net sideward movement 1303 of the central stage 1302 along a direction of the pull force over the primary long beam 1305. The movement of the primary long beam 1304-1307 is symmetrical about a central axis 1301.

FIG. 14 illustrates a top view of the nano-positioner indicating an in-plane rotational movement, according to one embodiment herein. With respect to FIG. 14, a lateral movement of the primary long beams 1402 towards a right hand direction leads to an anti-clockwise in-plane rotation of the central stage 1401. One primary long beam 1402 generates a specific in-plane rotation of the central stage 1401 in a direction similar to the direction of the lateral movement of the primary long beam 1402. Thus a net anti-clockwise rotation of the central stage 1401 is sum of the rotation produced by individual primary long beams 1402.

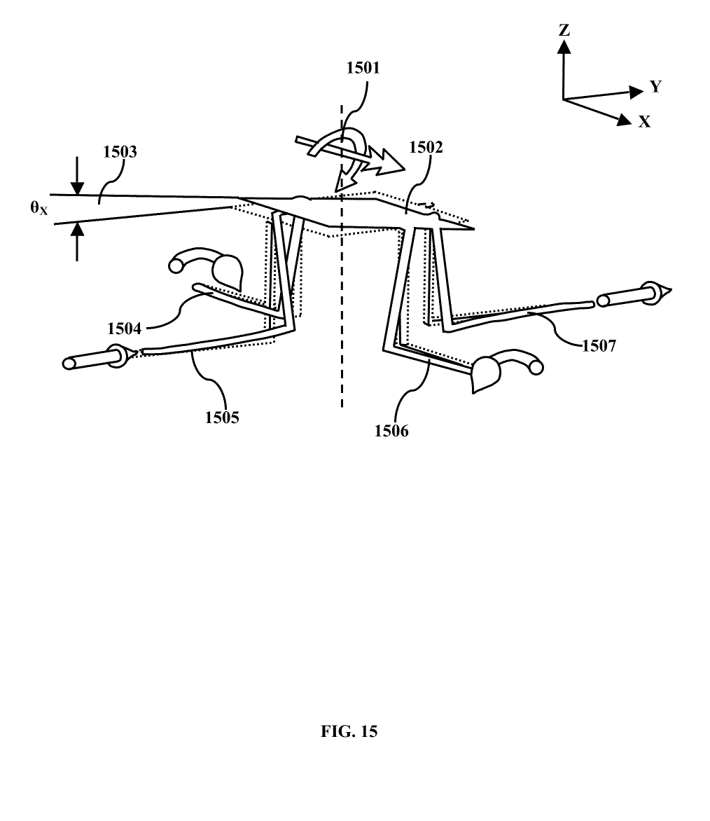

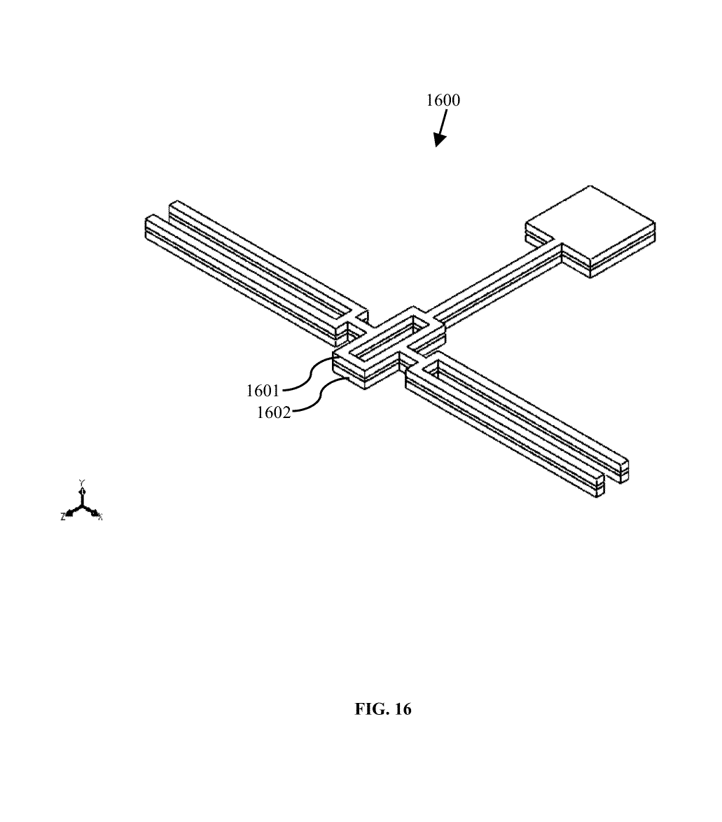

FIG. 15 illustrates a side view of the nano-positioner indicating an out-of-plane rotational movement, according to one embodiment herein. With respect to FIG. 15, a movement of the primary long beam (1504-1507) towards the central stage 1502 applies a vertical push force to the primary microbeam. The vertical push force applied on the primary microbeam leads to an upward movement 1503 of the central stage 1502.

Also a movement of the primary long beams 1504 and 1506 away from the central stage 1502 creates a vertical pull force on the primary microbeams. The vertical pull force applied on the secondary long beam leads to a downward movement of the central stage.

Further the secondary long beam connected at the orthogonal positions with respect to the secondary long beams 1505 and 1507 provides an upward movement to the central stage.

The movement of the primary long beam (1504-1507) is symmetrical about a central axis 1501.

FIG. 16 illustrates a top side perspective view of a micromanipulator fabricated with a plurality of Double-Deck-SOI wafers, according to one embodiment herein. With respect to FIG. 16, a microactuator 1600 is fabricated through a Double-Deck-Silicon on Interface wafer. Sandwiching a thin layer of silicon oxide between two microactuators 1601-1602 vertically forms the Double-Deck-SOI wafer. The Double-Deck-SOI wafer increases the rigidity of the microactuator 1600 while performing a movement. Also the Double-Deck-SOI wafer facilitates an out-of-plane tip movement of the microactuator.

During an out-of-plane tip movement in an upward direction, a tip of the primary long beam of an upper microactuator 1601 is moved in a backward direction and the tip of the primary long beam of a lower microactuator 1602 is moved in a forward direction.

During an out-of-plane movement in a downward direction, a tip of the primary long beam of the upper microactuator 1601 is moved in a forward direction and a tip of the primary long beam of the lower microactuator 1602 is moved in a backward direction. Hence the upper and the lower microactuators perform an in-plane movement to facilitate an out-of-plane movement of the central stage, which further provides a 3-DOF movement to the nano-positioner.

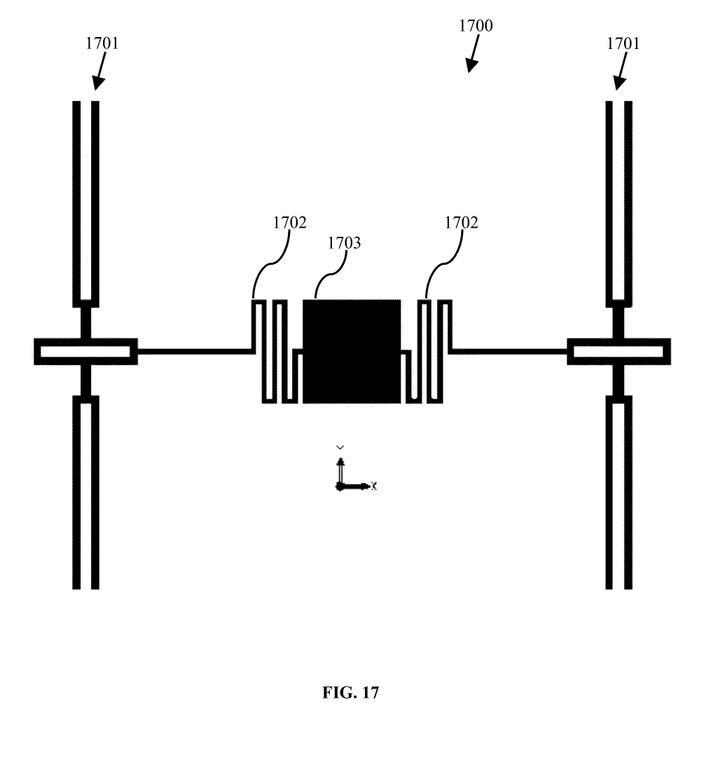

FIG. 17 illustrates a schematic diagram of a pair of micromanipulators with a serpentine shaped spring attached with a primary long beam, according to one embodiment herein. With respect to FIG. 17, the serpentine shaped spring 1702 attached with a primary long beam in a nano-positioner 1700 facilitates a movement of the microactuator along X-Axis, Y-Axis and an in-plane rotational movement. The serpentine shaped springs 1702 are connected in parallel, i.e. symmetric with the central stage 1703. The serpentine shaped springs 1702 of the micromanipulator 1701 avoids an unwanted out-of-plane rotation.

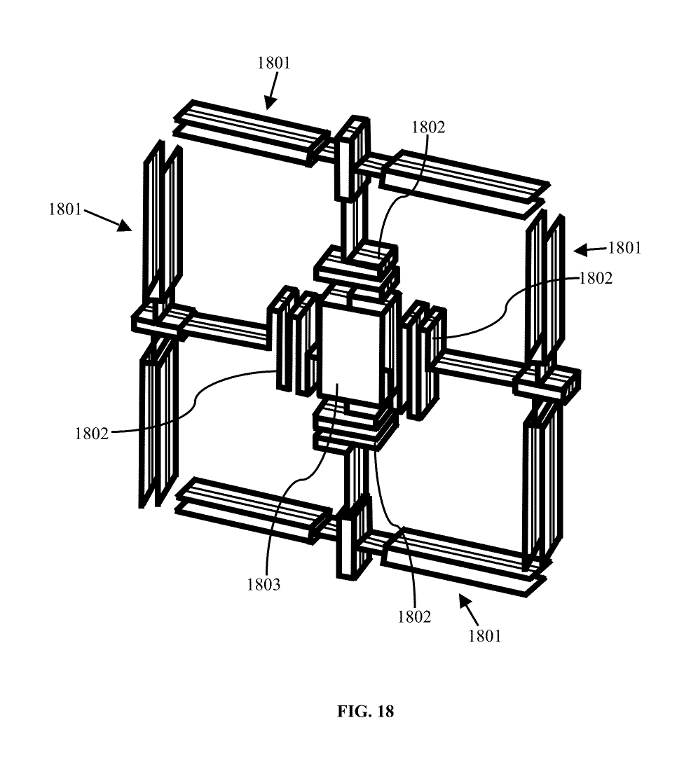

FIG. 18 illustrates a side perspective view of a nano-positioner fabricated with a plurality of Double-Deck-SOI wafers along with serpentine shaped spring attached to a primary long beam, according to one embodiment herein. With respect to FIG. 18, the four micromanipulators 1801 with the serpentine shaped spring 1802 attached to a primary long beam are further connected to the central stage 1803. The micromanipulators 1801 are fabricated with the plurality of Double-Deck-SOI wafers. The nano-positioner with respect to FIG. 18 facilitates a 5-DOF movement. The 5-DOF movements comprises a movement of the microactuator along an X-axis, Y-axis, Z-axis, θy direction and θz direction.

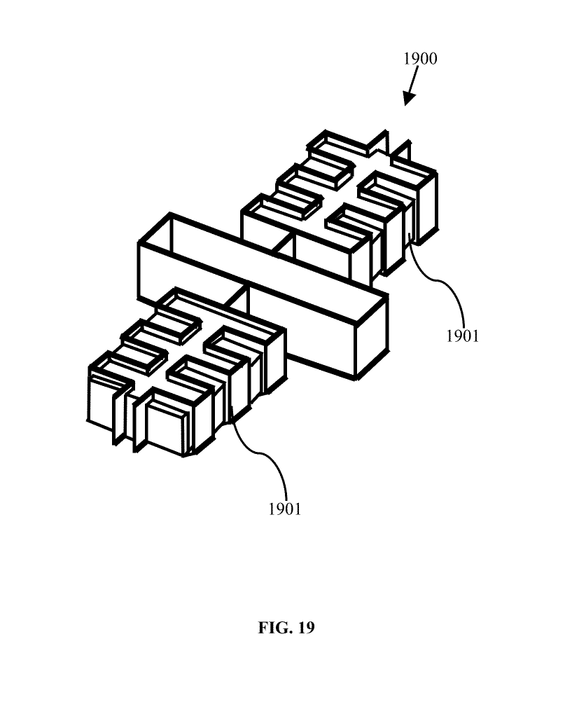

FIG. 19 illustrates a schematic diagram of a micromanipulator fabricated with a serpentine shaped primary long beam, according to one embodiment herein. With respect to FIG. 19, the primary long beam 1901 of the microactuator 1900 is formed in a serpentine shape to provide high displacement during a movement of the microactuator in various directions or axis. The movement in various directions comprises X axis, Y-axis, Z-axis, a θx direction, a θy direction and a θz direction.

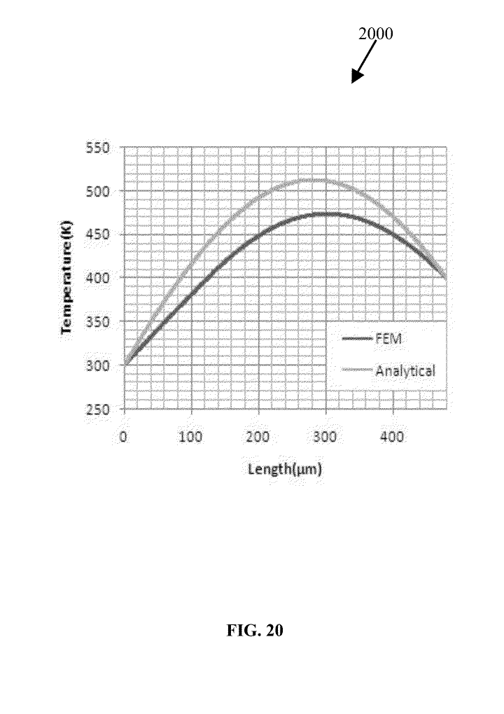

FIG. 20 illustrates a graph representing a comparison between the temperature distribution obtained by an analytical method and by a finite element method (FEM), according to one embodiment herein. With respect to FIG. 20, an analytical temperature distribution is compared with the temperature distribution obtained by an FEM method for a 480-micron silicon secondary microbeam with 40 sq. microns cross-section. The FEM method is an integrational method for calculating the small parametric values. The analytical manipulation is done under selected parametric values. The selected parametric values comprise a voltage difference between two ends of secondary microbeam maintained at 1.5 volts and the boundary temperatures fixed to 300 and 400 kelvin.

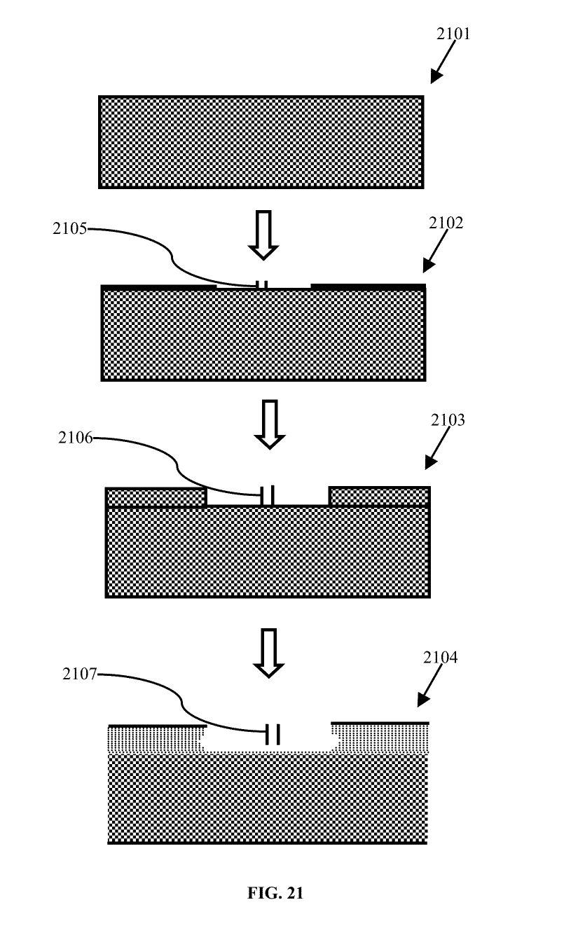

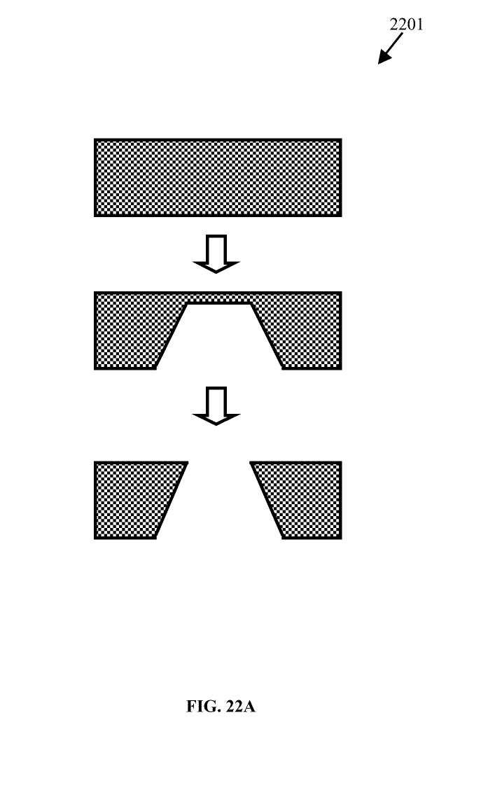

FIG. 21 illustrates a schematic diagram indicating a fabrication process of silicon wafers using a dry undercutting process, according to one embodiment herein. With respect to FIG. 21, a development of single crystal silicon is shown (2101). Further a membrane is formed on the single crystal silicon by the KOH method alongwith development of the conducting pads 2105 by the DRIE method (2102). The KOH method is a chemical etching process performed by treating the silicon wafer with potassium hydroxide (KOH). The deep reactive ion etching method (DRIE) is a chemical etching method by a reactive ionization of the silicon ionization. The DRIE method for the development of the conducting pads 2106 is continued until the conducting pads gain a specified length (2103). The conducting pads 2107 further undergoes through the dry undercutting process (2104).

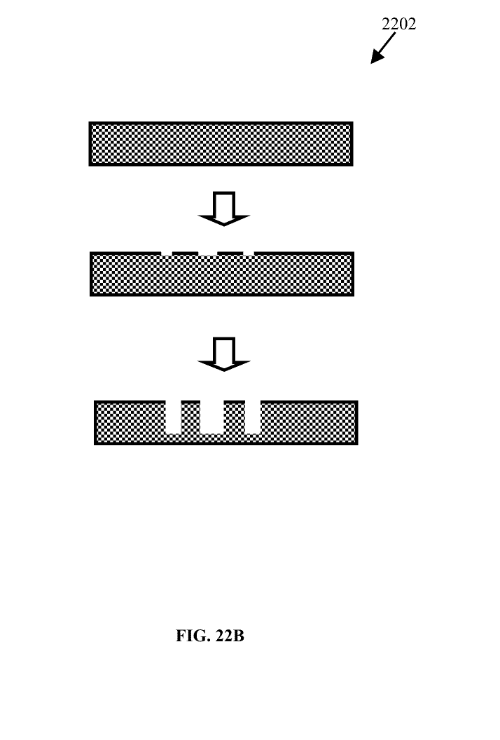

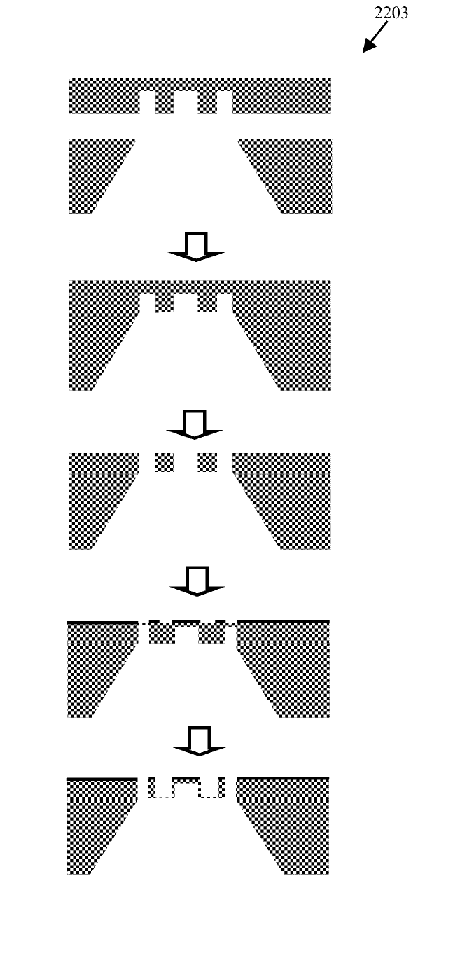

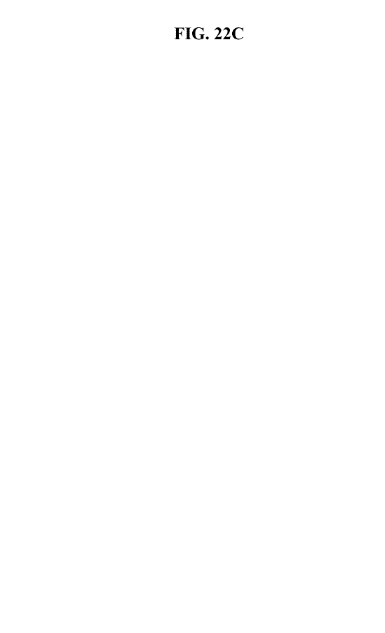

FIG. 22A illustrates a schematic diagram indicating a fabrication process of a silicon wafer with potassium hydroxide (KOH) truncated pyramid hole, according to one embodiment herein. With respect to FIG. 22A, a lower part of a bi-planar structure of a nano-positioner is developed 2201. The lower part of the bi-planar structure is fabricated by truncating a specific countered shaped hole (preferably pyramid shaped hole) in a single crystal silicon through the KOH process.

FIG. 22B illustrates a schematic diagram showing a fabrication of a truncated silicon wafer, according to one embodiment herein. With respect to FIG. 22B, the upper part of the bi-planar structure is developed through a KOH process 2202. The fabrication of the upper part of the bi-planar structure comprises a development of at-least three holes in single crystal silicon. The three holes lie in the same plane. The width of central hole is more than that of the other two holes, which are adjacent to the central hole.

FIG. 22C illustrates a schematic diagram indicating a fusion process of the silicon wafers illustrated in FIG. 22A and FIG. 22B, according to one embodiment herein. With respect to FIG. 22C, the upper part and the lower part of the bi-planar structure are joined together by a fusion bonding 2203.

The nano-positioner of the embodiments herein provides high degree of freedom (DOF). The nano-positioner of the embodiments herein facilitates a lateral, an axial and a rotational movement by using same set of microactuators. The nano-positioner of the embodiments herein facilitates a high displacement while performing a lateral, an axial and a rotational movement. The nano-positioner of the embodiments herein provides a symmetrical buckling effect while performing a lateral, axial and a rotational movement. The nano-positioner of the embodiments herein provides an in plane and an out-of-plane movement.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments, which as a matter of language might be said to fall there between.

What is claimed is:

1. A high degree of freedom (DOF) compliant nano-positioners, the system comprising:
a central stage and a plurality of micromanipulators connected to the central stage and wherein each of the plurality of micromanipulators comprises a micro-actuator, a primary long beam and a primary micro beam, and wherein the micro-actuator comprises a pair of conducting pads, a secondary micro-beam, a secondary long beam and a box spring; and
wherein a first tip of the primary micro-beam is connected to the central stage and wherein a second tip of the primary micro-beam is connected with a first tip of the primary long beam, wherein a second tip of the primary long beam is connected to the centre of a lateral side of the box spring, and wherein a first tip of the secondary long beam is connected to the centre of a lateral side of the box spring, and wherein a second tip of the secondary long beam is orthogonally connected to a centre of the secondary micro-beam, and wherein the primary long beam and the secondary long beam are connected to the box spring in perpendicular to each other, and wherein a first tip of the pair of conducting pads are connected to the secondary micro-beam orthogonally, and wherein a second tip of the pair of conducting pads are connected to a voltage source for supplying a preset amount of the voltage of the pair of conducting pads, and wherein the preset amount of the voltage is a voltage value required to cause a displacement in the micromanipulator.

2. The system according to claim 1, wherein the first tip of at-least two primary long beams are connected together to form a flexural joint of a micro-actuator, and wherein the second tip of the primary long beam is connected to the flexural joint of the micro-actuator to form the micromanipulator.

3. The system according to claim 1, wherein a degree of freedom (DOF) of the nano-positioner comprises a lateral movement and a rotational movement of the center stage.

4. The system according to claim 1, wherein a potential difference is developed between the two ends of the secondary micro-beam to allow a lateral movement of the secondary long beam, and wherein a voltage applied on the conducting pads arranged opposite to each other on a same line is equal.

5. The system according to claim 1, wherein a potential difference is developed between the two ends of the secondary micro-beam to allow a rotational movement of the secondary long beam and wherein a voltage applied on the conducting pads arranged opposite to each other on a diagonal line is equal.

6. The system according to claim 1, wherein an axial stiffness of the box spring is increased to increase an output displacement of the primary long beam of the nano-positioners, and wherein the output displacement is a lateral displacement or a rotational displacement or a combination of both.

7. The system according to claim 1, wherein a flexural stiffness of the box spring is reduced to increase an output displacement of the primary long beam of the nano-positioners, and wherein the output displacement is a lateral displacement or a rotational displacement or a combination of both.

8. The system according to claim 1, wherein the primary long beam further comprises a serpentine shaped spring to increase an in-plane rigidity of the nano-positioner.

9. The system according to claim 1, wherein the primary long beam is arranged in a shape of a ladder to avoid an out-of-plane displacement.

10. The system according to claim 1, wherein an at-least four micromanipulators are connected to at-least one central stage for providing a six degrees of freedom and wherein the six degrees of freedom comprises a movement in an X-plane, a Y-plane, a Z-plane, a θx plane, a θy plane and a θz plane.

11. The system according to claim 1, wherein the at-least four micromanipulators are fabricated with a plurality of Double-Deck-SOI wafers, and wherein the Double-Deck-SOI wafers are connected to at-least one central stage for providing a degree of freedom in at-least three directions, and wherein the degree of freedom in at-least three directions comprises a movement in an X-plane, a Y-plane and a Z-plane.

12. The system according to claim 1, wherein the at least four micromanipulators with the ladder shaped primary long beam are connected to one central stage for providing a 4-degrees of freedom, and wherein 4 degrees of freedom comprises a movement in an X-plane, a Y-plane, a Z-plane and a θx plane or a θy plane or a θz plane.

13. The system according to claim 1, wherein at-least four Double-Deck-SOI micromanipulators along with the primary long beam with the serpentine shaped spring are connected to at-least one central stage for providing a five degrees of freedom, and wherein the five degrees of freedom comprises a movement in an X-plane, a Y-plane, a Z-plane, a θy plane and a θz plane.

14. The system according to claim 1, wherein the micro-actuators are aligned along a direction of 100° to 110° to increase a buckling displacement, and wherein the buckling displacement is a lateral displacement or a rotational displacement or a combination of both.

15. The system according to claim 1, wherein a modulus of elasticity of the nanopositioner is varied from 169 Pa to 130 Pa for a respective variation in an alignment of the micro-actuators along the direction of 100° to 110° to increase the buckling displacement.

16. A method for designing high degree of freedom (DOF) nanopositioners from at-least 2-DOF micromanipulator, the method comprises:
forming a plurality of micromanipulators, and wherein forming the plurality of micromanipulators comprises forming a plurality of microactuators, a primary long beam and a primary micro beam;
connecting the plurality of micromanipulators on a central stage micro-actuator.

17. The method according to claim 16, wherein forming the micro-actuator further comprises:
connecting a first tip of the primary micro-beam to the central stage;
connecting a second tip of the primary micro-beam to a first tip of the primary long beam;
connecting a second tip of the primary long beam to a centre of a lateral side of the box spring;
connecting a first tip of the secondary long beam to the centre of a lateral side of the box spring;
connecting a second tip of the secondary long beam orthogonally to a centre of the secondary micro-beam, and wherein the primary long beam and the secondary long beam are connected to the box spring in perpendicular to each other;
connecting a first tip of the pair of conducting pads to the secondary micro-beam orthogonally;
connecting a second tip of the pair of conducting pads to a voltage source for supplying a preset amount of the voltage of the pair of conducting pads, and wherein the preset amount of the voltage is a voltage value required to cause a displacement in the micromanipulator.

18. The method according to claim 17, wherein a non-zero voltage is provided to the conducting pads of the pair of micromanipulators for facilitating a degrees of freedom, and wherein the degrees of freedom is a lateral movement or a rotational movement or a combination of both.

19. A fabrication method of developing a bi-planar structure for a high degree nano-positioner, the fabrication method comprising the steps of:
developing a lower layer, and wherein developing the lower layer comprises developing a potassium hydride (KOH) truncated pyramid hole, and wherein the KOH truncated pyramid hole acts as a handle wafer;
developing an upper layer, and wherein developing the upper layer further comprises developing a wafer with three holes, and wherein the three holes lie in the same plane on the wafer, and wherein the two holes lie on two opposite sides of a central hole and wherein a width of the two holes arranged on two opposite sides of the central hole is less than a width of the central hole;
masking a developed wafer with three holes; and
dry etching a masked wafer with three holes, and whereas a dry etching is done on a double polished wafer;
attaching the developed upper layer and the lower layer through a fusion bonding to form a bi-planar wafer, and wherein the handle wafer is attached with the conducting pad; and
performing a chemical mechanical planarization (CMP) over the bi-planar wafer, and wherein the CMP is done to reduce the thickness of the bi-planar wafer;
wherein a potassium hydroxide (KOH) etching is suitably used in place of CMP method, and wherein a deep reactive ion etching (DRIE) method is suitably used in place of the CMP method.
